(19) United States
(12) Patent Application Publication
(10) Pub. No.: US 2009/0231886 A1
(43) Pub. Date: Sep. 17, 2009

(54) POWER SUPPLY AND BOOTSTRAP CIRCUIT THEREOF

(75) Inventors: Chun-Hua Xia, Shanghai City (CN); Shih-Hao Liu, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/101,751

(22) Filed: Apr. 11, 2008

(30) Foreign Application Priority Data
Mar. 12, 2008 (TW) 97108696

(51) Int. Cl. H02M 3/335; H02M 1/00

(52) U.S. Cl. 363/20; 363/49

(57) ABSTRACT

A power supply and a bootstrap circuit thereof are provided. The bootstrap circuit includes a transistor, a first capacitor, a first impedance and a regulator circuit. The collector and the emitter of the transistor respectively serve as the input terminal and the output terminal of the bootstrap circuit. A terminal of the first capacitor is coupled to the collector of the transistor. A terminal of the first impedance is coupled to another terminal of the first capacitor. The regulator circuit is coupled to another terminal of the first impedance and the base of the transistor for clamping the voltage of the above-mentioned base at a predetermined voltage level.

### CROSS-REFERENCE TO RELATED APPLICATION

This application claims the priority benefit of Taiwan application serial no. 97108696, filed on Mar. 12, 2008. The entirety the above-mentioned patent application is hereby incorporated by reference herein and made a part of specification.

### BACKGROUND OF THE INVENTION

1. Field of the Invention

The present invention generally relates to a power supply and a bootstrap circuit thereof, and more particularly, to a power supply with less power consumption and a bootstrap circuit consuming power only during a starting course.

2. Description of Related Art

Along with the approaching energy crisis, the environmental awareness is gradually increasing among the public opinions. In recent years, US government has proposed some of energy efficiency standards, such as 80 Plus program, Energy Star program and the like so as to expectably govern the energy consumptions of electronic products. The above-mentioned energy efficiency standards have been applied to computer systems already, which restrict the power consumption of a computer in standby state to be lower than 3 W. Considering a power supply in a computer system usually has a conversion efficiency of 60%-70% only, much electrical energy is transformed to thermal energy and dissipated into the atmospheric air. Therefore, a power supply becomes one of principal energy-consuming parts in a computer system. Moreover, the above-mentioned power consumption restriction seriously challenges the existing relevant designs of a conventional power supply.

Although a current power supply has adopted quasi-resonance technique and synchronized rectification technique to promote the efficiency thereof, but many auxiliary circuits thereof still have unsolved power loss issues. FIG. 1 is a schematic circuit drawing of a power supply with a conventional bootstrap circuit. In FIG. 1, a resistor 102 and a capacitor 104 form a conventional bootstrap circuit. The capacitance of the capacitor 104 in the bootstrap circuit must be large enough to feed a pulse width modulation control circuit (PWM control circuit) 106 with a sufficient electric current. The resistance of the resistor 102 must be large enough too, so that any inrush current passing through the resistor 102 is avoided to damage the components. The problem for the above-mentioned power supply rests in that although the PWM control circuit 106 only consumes less than one watt during driving an metal oxide semiconductor transistor (MOS transistor) 108; however, the resistor 102 still consumes a quite large power after starting the power supply, which leads the computer system not to meet the above-mentioned energy efficiency standards.

### SUMMARY OF THE INVENTION

Accordingly, the present invention is directed to a bootstrap circuit, which is suitable for a power supply and consumes power only during the start of the power supply.

The present invention is also directed to a power supply, which consumes less power consumption than a conventional power supply.

The present invention provides a bootstrap circuit. The bootstrap circuit includes a transistor, a first capacitor, a first impedance and a regulator circuit. The collector and the emitter of the transistor serve as an input terminal and an output terminal of the bootstrap circuit respectively. A terminal of the first capacitor is coupled to the collector of the transistor, a terminal of the first impedance is coupled to another terminal of the first capacitor. The regulator circuit is coupled to another terminal of the first impedance and the base of the transistor for clamping the voltage at the above-mentioned base at a predetermined voltage level.

The present invention also provides a power supply. The power supply includes a bridge rectifier, a first capacitor, a transformer, a switch, a first diode, a second capacitor, a PWM control circuit and a bootstrap circuit. The bridge rectifier has two AC input terminals, a positive output terminal and a negative output terminal. A terminal of the first capacitor is coupled to the positive output terminal and another terminal thereof is coupled to the negative output terminal and a common voltage level. The transformer has a primary winding and a secondary winding, and a terminal of the primary winding is coupled to the positive output terminal. The switch has a first terminal, a second terminal and a control terminal. The first terminal of the switch is coupled to another terminal of the primary winding and the second terminal of the switch is coupled to a common voltage level. The anode of the first diode is coupled to a terminal of the secondary winding. A terminal of the second capacitor is coupled to the cathode of the first diode, and another terminal of the second capacitor is coupled to another terminal of the secondary winding and the common voltage level. The input terminal of the PWM control circuit is coupled to the cathode of the first diode and the output terminal thereof is coupled to the control terminal of the switch. The bootstrap circuit is coupled between the positive output terminal and the input terminal of the PWM control circuit. When a power voltage is produced on the positive output terminal, the bootstrap circuit provides the input terminal of the PWM control circuit with a starting voltage and the bootstrap circuit would be automatically turned off after a predetermined time.

In an embodiment of the present invention, the above-mentioned bootstrap circuit of the power supply adopts the above-described bootstrap circuit architecture.

The bootstrap circuit of the present invention is composed of a transistor, a capacitor, an impedance and a regulator circuit, wherein the capacitor and the transistor are used to produce a time constant. When the input terminal of the bootstrap circuit has a momentary variation of voltage, the capacitor makes the transient voltage coupled to the base of the transistor through the impedance, so that the transistor can be quickly turned on to establish a starting voltage at the emitter of the transistor. After the above-mentioned constant time, the bootstrap circuit enters a stable state. At this time, the capacitor takes open-circuit state to turn off the transistor, which makes the bootstrap circuit automatically turned off and the bootstrap circuit has no more power consumption. In addition, the power supply of the present invention can adopt the above-described bootstrap circuit architecture. Since the adopted bootstrap circuit consumes power only during the course of starting the power supply, therefore, the power supply of the present invention consumes less power in standby state and has an overall power consumption less than that of the conventional power supply. A computer system employing the power supply or the bootstrap circuit of the present invention can thereby easily meet the energy efficiency standards such as 80 Plus, Energy Star and the like.

### BRIEF DESCRIPTION OF THE DRAWINGS

Other objectives, features and advantages of the present invention will be further understood from the further technological features disclosed by the embodiments of the present invention wherein there are shown and described preferred embodiments of this invention, simply by way of illustration of modes best suited to carry out the invention.

FIG. 1 is a schematic circuit drawing of a power supply with a conventional bootstrap circuit.

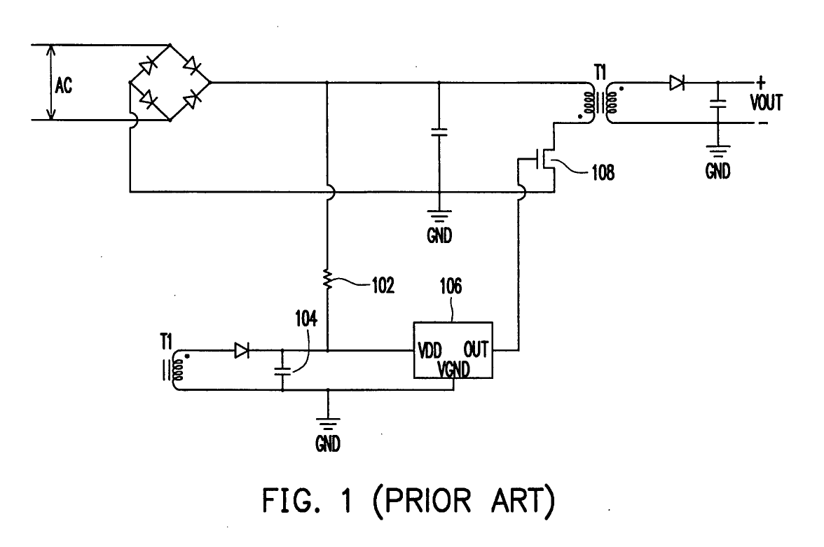

FIG. 2 is a schematic circuit drawing of a power supply and the bootstrap circuit thereof according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

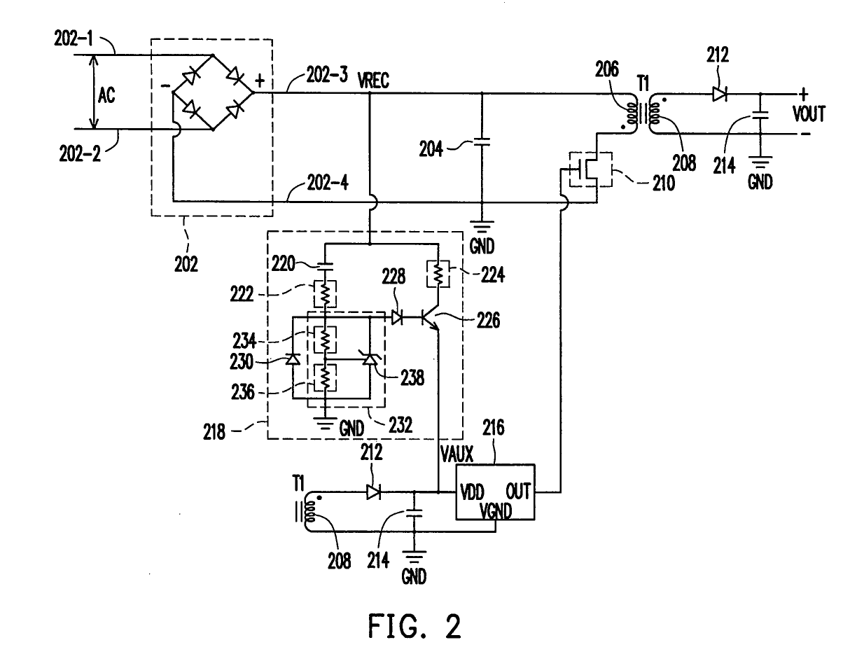

FIG. 2 is a schematic circuit drawing of a power supply and the bootstrap circuit thereof according to an embodiment of the present invention. The power supply includes a bridge rectifier 202, a capacitor 204, a transformer T1, a switch 210, a diode 212, a capacitor 214, a PWM control circuit 216 and a bootstrap circuit 218. The bridge rectifier 202 has two AC input terminals 202-1 and 202-2, a positive output terminal 202-3 and a negative output terminal 202-4. A terminal of the capacitor 204 is coupled to the positive output terminal 202-3 and another terminal thereof is coupled to the negative output terminal 202-4 and a common voltage level GND. The transformer T1 has a primary winding 206 and a secondary winding 208, and a terminal of the primary winding 206 is coupled to the positive output terminal 202-3. The switch 210 has a first terminal, a second terminal and a control terminal, wherein the first terminal is coupled to another terminal of the primary winding 206 and the second terminal of the switch 210 is coupled to the common voltage level GND.

The anode of the diode 212 is coupled to a terminal of the secondary winding 208, a terminal of the capacitor 214 is coupled to the cathode of the diode 212 and another terminal of the capacitor 214 is coupled to another terminal of the secondary winding 208 and the common voltage level GND. The two terminals of the capacitor 214 are used to produce an output OUT of the power supply. The PWM control circuit 216 has an input terminal VDD, an output terminal OUT and a grounding terminal VGND, wherein the input terminal VDD is coupled to the cathode of the diode 212 and the output terminal OUT is coupled to the control terminal of the switch 210. The bootstrap circuit 218 is coupled between the positive output terminal 202-3 and the input terminal VDD of the PWM control circuit 216. When a power voltage VREC is produced at the positive output terminal 202-3, the bootstrap circuit 218 provides a starting voltage VAUX to the input terminal VDD of the PWM control circuit 216 and the bootstrap circuit 218 would be automatically turned off after a predetermined time.

In the present embodiment, the bootstrap circuit 218 includes a capacitor 220, two impedances 222 and 224, a transistor 226, two diodes 228 and 230 and a regulator circuit 232. The collector of the transistor 226 is coupled to the positive output terminal 202-3 via the impedance 224, and the emitter thereof is coupled to the input terminal VDD of the PWM control circuit 216 for outputting the starting voltage VAUX. A terminal of the capacitor 220 is coupled to the positive output terminal 202-3 and the impedance 224 and another terminal thereof is coupled to the regulator circuit 232 via the impedance 222. The anode of the diode 230 is coupled to the common voltage level GND and the cathode thereof is coupled to the impedance 222. The anode of the diode 228 is coupled to the regulator circuit 232 and the cathode thereof is coupled to the base of the transistor 226. The regulator circuit 232 is coupled to the impedance 222 and the anode of the diode 228 for clamping the voltage of the above-mentioned anode at a predetermined voltage level.

The above-mentioned regulator circuit 232 includes two impedances 234 and 236 and a shunt regulator 238. A terminal of the impedance 234 is coupled to the impedance 222 and the anode of the diode 228, and the impedance 236 is coupled between another terminal of the impedance 234 and the common voltage level GND. The shunt regulator 238 has an anode terminal, a cathode terminal and a reference terminal, wherein the cathode terminal of the shunt regulator 238 is coupled to the anode of the diode 228, the anode terminal of the shunt regulator 238 is coupled to the common voltage level GND and the reference terminal of the shunt regulator 238 is coupled to another terminal of the impedance 234. The shunt regulator 238 determines the voltage between the anode terminal and the cathode terminal thereof according to the voltage of the reference terminal. The switch 210 herein can be implemented by using a metal oxide semiconductor transistor (MOS transistor), the impedances 222, 224, 234 and 236 can be implemented by using resistors and the transistor 226 can be implemented by using an NPN-type power transistor.

When the AC input terminals 202-1 and 202-2 of the bridge rectifier 202 receive an AC power, a job of converting AC into DC is executed, so that a pulse DC is output through the positive output terminal 202-3 and the negative output terminal 202-4. The polarities of the DC power voltage are shown in the figure, where ‘+’ represents positive polarity and ‘−’ represents negative polarity. At the time, a momentary variation of the power voltage VREC at the positive output terminal 202-3 enables the capacitor 220 to couple the voltage to the node where the capacitor 220 and the impedance 222 are coupled to each other. After that, the high voltage is delivered to the base of the transistor 226 through the impedance 222 and the diode 228 in sequence, which further quickly turns on the transistor 226. In this way, the transistor 226 is able to quickly produce the starting voltage VAUX at the emitter thereof and deliver the starting voltage VAUX to the input terminal VDD of the PWM control circuit 216. The PWM control circuit 216 then starts to work and drives the switch 210 to enable the transformer T1 to run.

After the transformer T1 is operated, the power voltage required by the PWM control circuit 216 is received through the diode 212 and the capacitor at this time functions to keep the power voltage stable. As to the bootstrap circuit 218, since the bootstrap circuit 218 has a certain operation time, i.e. a time constant preset by the capacitor 220 and the impedance 222; thus, after the capacitor 220 is charged for a while and gets a stable state, the capacitor 22o takes open-circuit state to turn off the transistor 226, which automatically turns off the bootstrap circuit 218 to stop the consumption of power. In other words, as the power supply starts, the bootstrap circuit 218 is in charge of starting the transformer T1. Once the transformer Ti is started to produce the power voltage required by the PWM control circuit 216, the bootstrap circuit 218 is automatically turned off. Therefore, the bootstrap circuit 218 consumes power only during starting the power supply, and therefore the power supply consumes less power in standby state and the power supply of the present invention thereby has a less overall power consumption than that of a conventional power supply.

Particularly, in addition to the function of the regulator circuit 232 in the above-mentioned bootstrap circuit 218 to clamp the voltage of the anode of the diode 228 at a predetermined voltage level so as to prevent the transistor 226 from a transient surge voltage resulting a possible damage, a user is allowed to adjust the ratio of the impedance 234 over the impedance 236 so as to determine the starting voltage VAUX. The diode 230 herein functions to protect other components from producing a negative voltage and the impedance 224 is served as a current-limiting resistor, which ensures the operation of the transistor 226 in a safe operation area (SOA). Note that in the bootstrap circuit 218, the impedance 224 and the diodes 228 and 230 are optional parts only, and the user may decide whether or not to dispose the impedance 224 and the diodes 228 and 230 according to a real design need.

In summary, the bootstrap circuit of the present invention is composed of a transistor, a capacitor, an impedance and a regulator circuit, wherein the capacitor and the impedance are used to produce a time constant. When a momentary voltage variation occurs at the input terminal of the bootstrap circuit, the capacitor couples the transient voltage to the base of the transistor through the impedance so as to quickly turn on the transistor and to produce a starting voltage at the emitter of the transistor. When the bootstrap circuit enters stable state after the above-mentioned constant time, the capacitor takes open-circuit state to turn off the transistor, which enables the bootstrap circuit automatically to be turned off and not consume any power. In addition, the power supply of the present invention can adopt the above-described bootstrap circuit architecture. Since the bootstrap circuit consumes power only during the starting stage of the power supply, therefore, the power supply of the present invention consumes less power in standby state compared to the prior art. In this way, the power supply or bootstrap circuit of the present invention facilitates a computer system employing the power supply and the bootstrap circuit reaching the requirements of energy efficiency standards such as 80 Plus, Energy Star and the like.

The above are preferred embodiments of the present invention, however, they are not intended to limit the scope of the present invention. It will be apparent to those skilled in the art that various modifications and equivalent variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A bootstrap circuit, comprising:
a transistor, having a collector and an emitter, wherein the collector and the emitter respectively serve as an input terminal and an output terminal of the bootstrap circuit;
a first capacitor, having a terminal coupled to the collector of the transistor;
a first impedance, having an terminal coupled to another terminal of the first capacitor; and
a regulator circuit, coupled to another terminal of the first impedance and a base of the transistor for clamping voltage of the base at a predetermined voltage level.

2. The bootstrap circuit according to claim 1, wherein the regulator circuit comprises:
a second impedance, having a terminal coupled to another terminal of the first impedance and the base of the transistor;
a third impedance, coupled between another terminal of the second impedance and a common voltage level; and
a shunt regulator, having an anode terminal, a cathode terminal and a reference terminal, wherein the cathode terminal is coupled to the base of the transistor, the anode terminal is coupled to the common voltage level and the reference terminal is coupled to another terminal of the second impedance, and the shunt regulator determines a voltage between the anode terminal and the cathode terminal thereof according to a voltage at the reference terminal thereof.

3. The bootstrap circuit according to claim 1, further comprising a second impedance coupled between the collector of the transistor and the first capacitor, wherein a node where the second impedance and the first capacitor are coupled to each other serve as the input terminal of the bootstrap circuit.

4. The bootstrap circuit according to claim 1, further comprising a first diode having an anode and a cathode, wherein the anode of the first diode is coupled to the common voltage level and the cathode thereof is coupled to another terminal of the first impedance.

5. The bootstrap circuit according to claim 1, further comprising a first diode having an anode and a cathode, wherein the anode of the first diode is coupled to the regulator circuit and the cathode thereof is coupled to the base of the transistor.

6. A power supply, comprising:
a bridge rectifier, having two AC input terminals, a positive output terminal and a negative output terminal;
a first capacitor, having a first terminal and a second terminal, wherein the first terminal is coupled to the positive output terminal and the second terminal is coupled to the negative output terminal and a common voltage level;
a transformer, having a primary winding and a secondary winding, wherein a first terminal of the primary winding is coupled to the positive output terminal;
a switch, having a first terminal, a second terminal and a control terminal, wherein the first terminal of the switch is coupled to a second terminal of the primary winding and the second terminal of the switch is coupled to the common voltage level;
a first diode, having an anode coupled to a terminal of the secondary winding;
a second capacitor, having a first terminal and a second terminal, wherein the first terminal is coupled to the cathode of the first diode and the second terminal is coupled to another terminal of the secondary winding and the common voltage level;
a pulse width modulation control circuit, having an input terminal and an output terminal, wherein the input terminal is coupled to the cathode of the first diode and the output terminal is coupled to the control terminal of the switch; and
a bootstrap circuit, coupled between the positive output terminal and the input terminal of the pulse width modulation control circuit, wherein when the positive output terminals produce a power voltage, the bootstrap circuit provides a starting voltage to the input terminal of the pulse width modulation control circuit and is automatically turned off after a predetermined time.

7. The power supply according to claim 6, wherein the bootstrap circuit comprises:
a transistor, having a collector and an emitter, wherein the collector is coupled to the positive output terminal and the emitter is coupled to the input terminal of the pulse width modulation control circuit for outputting the starting voltage;
a third capacitor, having a first terminal coupled to the collector of the transistor;
a first impedance, having a first terminal coupled to a second terminal of the third capacitor; and
a regulator circuit, coupled to a second terminal of the first impedance and the base of the transistor for clamping the voltage of the above-mentioned base at a predetermined voltage level.

8. The power supply according to claim 7, wherein the regulator circuit comprises:
a second impedance, having a terminal coupled to the second terminal of the first impedance and the base of the transistor;
a third impedance, coupled between a second terminal of the second impedance and the common voltage level; and
a shunt regulator, having an anode terminal, a cathode terminal and a reference terminal, wherein the cathode terminal is coupled to the base of the transistor, the anode terminal is coupled to a common voltage level and the reference terminal is coupled to another terminal of the second impedance, and the shunt regulator determines the voltage between the anode terminal and the cathode terminal thereof according to the voltage at the reference terminal thereof.

9. The power supply according to claim 7, wherein the bootstrap circuit further comprises a second impedance, and the second impedance is coupled between the collector of the transistor and the positive output terminal.

10. The power supply according to claim 7, wherein the bootstrap circuit further comprises a second diode having an anode and a cathode, wherein the anode of the second diode is coupled to the common voltage level and the cathode thereof is coupled to the second terminal of the first impedance.

11. The power supply according to claim 7, wherein the bootstrap circuit further comprises a second diode having an anode and a cathode, wherein the anode of the second diode is coupled to the regulator circuit and the cathode thereof is coupled to the base of the transistor.
